(19) United States
(12) Patent Application Publication
(10) Pub. No.: US 2024/0319494 A1
(43) Pub. Date: Sep. 26, 2024

(54) LARGE-ANGLE LASER SCANNING PROJECTION DEVICE

(71) Applicant: Shenzhen Raythink Automotive Electronics Co., Ltd., Shenzhen (CN)

(72) Inventors: Deh-Ming Shyu, Shenzhen (CN); Rui Lu, Shenzhen (CN); Shuguang Huang, Shenzhen (CN); Yingjun Wang, Shenzhen (CN)

(21) Appl. No.: 18/504,184

(22) Filed: Nov. 8, 2023

(30) Foreign Application Priority Data
Mar. 21, 2023 (CN) 202320650342.2

(51) Int. Cl. G02B 26/10

(52) U.S. Cl. CPC G02B 26/105

(57) ABSTRACT

Disclosed in the present application is a large-angle laser scanning projection device, including: a light source generator, which is used to emit a laser beam outwards; a first lens, which is arranged on an outlet optical path of the light source generator and used to change a divergence angle of the laser beam; a scanning galvanometer, which is arranged on an outlet optical path of the first lens and is capable of realizing a rotating motion and used to reflect the laser beam incident on a surface of the scanning galvanometer to a second lens at a different angle when carrying out the rotating motion.

### CROSS-REFERENCE TO RELATED APPLICATION

The present application claims priority from Chinese Patent Application No. 202320650342.2 filed on Mar. 21, 2023, the contents of which are incorporated herein by reference in their entirety.

### FIELD OF TECHNOLOGY

The present application relates to the technical field of laser scanning projection, in particular to a large-angle laser scanning projection device.

### BACKGROUND

Nowadays, development of laser technology is getting faster and faster, and it has been applied to many fields of life, such as laser scanning projection, optical communication, laser processing and three-dimensional scanning. The laser scanning projection itself has obvious advantages, such as high brightness, high contrast, small volume size and low cost.

When the laser scanning projection is used, a scanning galvanometer used can finish rotation and scanning in two axes, so that an image is projected in a rectangular area, and the area of the projection is determined by a range of a rotation angle of the scanning galvanometer and a projection distance. In the case of not increasing the projection distance, in order to increase the area of the projection, it is necessary to configure an angle enlargement device, such as a wide-angle conversion lens, but this would significantly increase the volume, weight, assembly difficulty and cost of the laser scanning projection device, so it needs to be improved.

### SUMMARY

The present application aims to provide a large-angle laser scanning projection device. The device adopts an optical structure to increase the area of projection of the laser scanning projection device, that is, two lenses are respectively arranged between a light source generator and a scanning galvanometer, as well as on an outlet optical path of the scanning galvanometer, and a divergence angle of a laser beam is changed through the lenses, so as to achieve the purpose of increasing the area of projection. It has a small overall volume and a low cost, is easy for installation and quantify production.

In order to achieve the above purpose, the following technical schemes are adopted:

A large-angle laser scanning projection device, comprising:

a light source generator, which is used to emit a laser beam outwards;

a first lens, which is arranged on an outlet optical path of the light source generator and used to change a divergence angle of the laser beam;

a scanning galvanometer, which is arranged on an outlet optical path of the first lens and is capable of realizing a rotating motion and used to reflect the laser beam incident on a surface of the scanning galvanometer to a second lens at a different angle when carrying out the rotating motion; and

the second lens, which is arranged on an outlet optical path of the scanning galvanometer and used to change a divergence angle of the laser beam which is reflected by the scanning galvanometer.

Further, a transmission gear is mounted on the back side of the scanning galvanometer.

Further, the transmission gear and the scanning galvanometer have an integrated structure.

Further, the transmission gear is used for a meshing connection with a rotating shaft of an external motor.

Further, the transmission gear has a semicircular structure.

Further, the focal length f1 of the first lens satisfies f1>0.

Further, the focal length f2 of the second lens satisfies f2<0.

Further, f1>−2f 2.

Further, the curvature radius R11 of a side of the first lens near the light source generator is less than the curvature radius R12 of the other side of the first lens.

With the above schemes, the present application has the following beneficial effects:

The device adopts the optical structure to increase the area of projection of the laser scanning projection device, that is, two lenses are respectively arranged between the light source generator and the scanning galvanometer, as well as on the outlet optical path of the scanning galvanometer, and the divergence angle of the laser beam is changed through the lenses, so as to achieve the purpose of increasing the area of projection. It has a small overall volume and a low cost, is easy for installation and quantify production.

### BRIEF DESCRIPTION OF THE DRAWINGS

FIG. 1 is a structural schematic diagram of the present application;

FIG. 2a is an optical path diagram of a scanning galvanometer rotated 10° C. counterclockwise in an embodiment of the present application;

FIG. 2b is an optical path diagram of the scanning galvanometer without rotation in an embodiment of the present application;

FIG. 2c is an optical path diagram of the scanning galvanometer rotated 10° C. clockwise in an embodiment of the present application.

Reference numbers are described as follows:
10—light source generator; 11—scanning galvanometer;
12—first lens; 13—second lens;
14—transmission gear; 15—rotating shaft of motor.

### DESCRIPTION OF THE EMBODIMENTS

The present application is described in detail in combination with the attached drawings and specific embodiments.

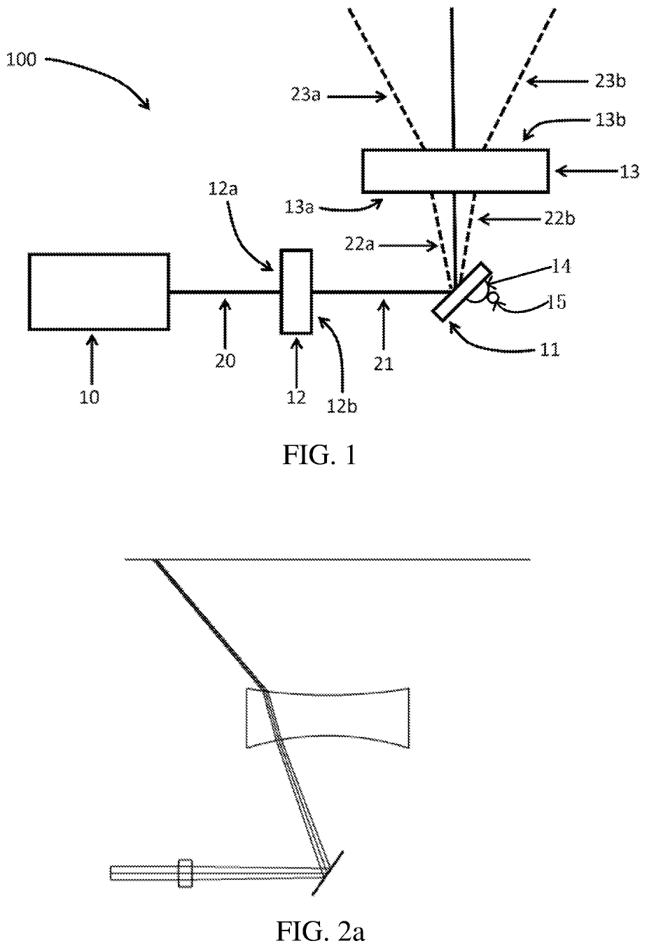

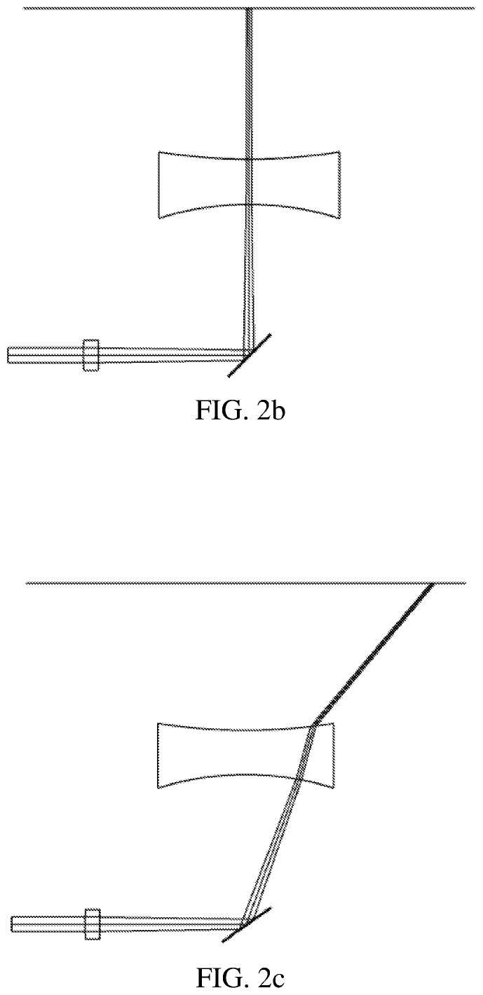

Refer to FIG. 1 and FIG. 2a and FIG. 2c, provided in the present application is a large-angle laser scanning projection device, comprising: a light source generator 10, which is used to emit a laser beam outwards; a first lens 12, which is arranged on an outlet optical path of the light source generator 10 and used to change a divergence angle of the laser beam; a scanning galvanometer 11, which is arranged on an outlet optical path of the first lens 12 and is capable of realizing a rotating motion and used to reflect the laser beam incident on a surface of the scanning galvanometer to a second lens 13 at a different angle when carrying out the rotating motion; and the second lens 13, which is arranged on an outlet optical path of the scanning galvanometer 11 and used to change a divergence angle of the laser beam which is reflected by the scanning galvanometer 11.

FIG. 1 shows a laser scanning projection device 100 provided in the embodiment, wherein 12a means a front surface of the first lens 12, 12b means a back surface of the first lens 12, 13a means a front surface of the second lens 13, 13b means a back surface of the second lens 13, 20 means the laser beam generated by the light source generator 10, 21 means a light beam generated by the laser beam 20 through the first lens 12, 22a means a left boundary light beam after the light beam 21 is emitted by the scanning galvanometer 11, 22b means a right boundary light beam after the light beam 21 is emitted by the scanning galvanometer 11 (the scanning galvanometer 11 is capable of carrying out the rotating motion, as shown in FIG. 2a to FIG. 2c, the light beam can be reflected to the second lens 13 at the different angle when the scanning galvanometer 11 rotates), 23a means the light beam after the light beam 22a is emitted through the second lens 13, and 23b means the light beam after the light beam 22b is emitted through the second lens 13.

When working, the light source generator 10 generates the laser beam 20, and the laser beam 20 changes a divergence angle of the beam through the first lens 12 to form the light beam 21; the light beam 21 changes a travel direction of the light beam through the scanning galvanometer 11, and the light beam 22a and the light beam 22b are the scanning range boundaries reached by the light beam 21 being changed the direction through the scanning galvanometer 11; and the light beam 23a and the light beam 23b are the scanning range boundaries reached by the light beam 22a and the light beam 22b being changed the travel direction of the light beams through the second lens 13. As can be seen from FIG. 1, the scanning range of the light beam reflected by the scanning galvanometer 11 can be expanded by using this device from a range of the original light beam 22a to light beam 22b to a range of the light beam 23a to the light beam 23b (which is expanded by about 1.5 to 3 times).

In an embodiment, a transmission gear 14 is mounted on the back side of the scanning galvanometer 11. The transmission gear 14 can be connected to a rotating shaft 15 of an external motor, the rotating shaft is driven by the motor and drives through the transmission gear 14 the scanning galvanometer 11 to rotate. Meanwhile, in another embodiment, the transmission gear 14 and the scanning galvanometer 11 have an integrated structure. With a design of the integrated structure, the number of assembly processes is reduced and assembly efficiency is improved. Meanwhile, in a preferred embodiment, the transmission gear 14 has a semicircular structure, one side of the transmission gear 14 is integrated and connected with the scanning galvanometer 11, and an outer wall of a curved edge of the transmission gear 14 is provided with a tooth line meshing with the rotating shaft 15 of motor. Such structural design can improve the rotation stability of the scanning galvanometer 11.

Preferably, the focal length f1 of the first lens 12 satisfies f1>0; the focal length f2 of the second lens 13 satisfies f2<0; and f1>−2f2; the curvature radius R11 of a side of the first lens 12 near the light source generator 10 is less than the curvature radius R12 of the other side of the first lens 12; and the curvature radius R21 of a side of the second lens 13 near the scanning galvanometer 11 is greater than the curvature radius R22 of the other side of the second lens 13.

In one embodiment, the light beam generated by the laser generator 10 has a diameter of 0.5 mm and a light source is of 550 nm; the scanning galvanometer 11 is placed at a position of 45° (45° from a horizontal plane), and a rotation angle is +/−10°; and the focal length f1 of the first lens 12 is +32.785 mm, and the focal length f2 of the second lens 13 is −13.884 mm. The curvature radius, thickness and lens material of the front and back surfaces of the first lens 12 and the second lens 13 are shown in the table below.

TABLE 1
Related parameters of the first lens and the second lens

| | Radius of | | | Light |
|---|---|---|---|---|
| | curvature | Thickness | Lens | transmission |
| Surface position | (mm) | (mm) | material | diameter (mm) |
| Object plane | infinity | infinity | | 0.00 |
| (Laser source) | | | | |
| Diaphragm | infinity | 5.00 | | 0.50 |
| plane | | | | |
| Front surface | 17.00 | 1.00 | N-BK7 | 1.00 |
| of first lens | | | | |
| Back surface | infinity | 10.00 | | 0.49 |
| of first lens | | | | |
| Scanning | infinity | 0.00 | MIRROR | 2.00 |
| galvanometer | | | | |
| Front surface | 20.00 | −3.00 | P-SF67 | 6.00 |
| of second lens | | | | |
| Back surface | −37.40 | −10.00 | | 6.00 |
| of second lens | | | | |
| Image plane | infinity | 0.00 | | 30.00 |

Optical path simulation results are as shown in FIG. 2a to FIG. 2c. When the scanning galvanometer 11 is rotated from −10° to +10°, the optical path changes are as shown in FIG. 2a to FIG. 2c. When the first lens 12 and the second lens 13 are not added, the laser scanning range is 40°, and when the first lens 12 and the second lens 13 are added, the laser scanning range is 80°. Therefore, in this embodiment, the laser scanning range can be doubled by using the first lens 12 and the second lens 13.

The above are only preferred embodiments of the present application, and are not used to limit the present application, and any modification, equivalent replacement and improvement made within the spirit and principle of the present application shall be included in the protection scope of the present application.

What is claimed is:

1. A large-angle laser scanning projection device, comprising:
a light source generator, which is used to emit a laser beam outwards;
a first lens, which is arranged on an outlet optical path of the light source generator and used to change a divergence angle of the laser beam;
a scanning galvanometer, which is arranged on an outlet optical path of the first lens and is capable of realizing a rotating motion and used to reflect the laser beam incident on a surface of the scanning galvanometer to a second lens at a different angle when carrying out the rotating motion; and
the second lens, which is arranged on an outlet optical path of the scanning galvanometer and used to change a divergence angle of the laser beam which is reflected by the scanning galvanometer.

2. The large-angle laser scanning projection device according to claim 1, wherein a transmission gear is mounted on the back side of the scanning galvanometer.

3. The large-angle laser scanning projection device according to claim 2, wherein the transmission gear and the scanning galvanometer have an integrated structure.

4. The large-angle laser scanning projection device according to claim 2, wherein the transmission gear is used for a meshing connection with a rotating shaft of an external motor.

5. The large-angle laser scanning projection device according to claim 2, wherein the transmission gear has a semicircular structure.

6. The large-angle laser scanning projection device according to claim 1, wherein the focal length f₁ of the first lens satisfies f₁>0.

7. The large-angle laser scanning projection device according to claim 6, wherein the focal length f₂ of the first lens satisfies f₂<0.

8. The large-angle laser scanning projection device according to claim 7, wherein f₁>−2f₂.

9. The large-angle laser scanning projection device according to claim 1, wherein the curvature radius R₁₁ of a side of the first lens near the light source generator is less than the curvature radius R₁₂ of the other side of the first lens.

10. The large-angle laser scanning projection device according to claim 1, wherein the curvature radius R21 of a side of the second lens near the scanning galvanometer is greater than the curvature radius R22 of the other side of the second lens.
